(19) United States
(12) Patent Application Publication
(10) Pub. No.: US 2026/0163319 A1
(43) Pub. Date: Jun. 11, 2026

(54) ELECTRICAL EXTENSION SYSTEM FOR A CABLE, ELECTRICAL EXTENSION KIT FOR A CABLE, AND ASSEMBLY METHOD

(71) Applicant: MAGIK ELEK SAS, Paris (FR)

(72) Inventor: Suthan ATPUTHARAJAH, Villemomble (FR)

(21) Appl. No.: 19/123,956

(22) PCT Filed: Oct. 23, 2023
(86) PCT No.: PCT/EP2023/079518

§ 371 Date: Apr. 24, 2025

(30) Foreign Application Priority Data
Oct. 24, 2022 (FR) FR2211035

(51) Int. Cl. H01R 31/06; H01R 13/50

(52) U.S. Cl. CPC H01R 31/06; H01R 13/50

(57) ABSTRACT

An electrical extension system for a cable including at least one connection housing, the connection housing being formed by a lower portion coupled to an upper portion, the connection housing including a connector that allows a flat cable to be electrically connected to a round cable, the round cable being composed of two conductive wires, each conductive wire being attached to the connector of the housing the connection housing also including, at a first end, an insertion slot in the lower portion thereof for the passage of the flat cable and two openings at a second end, opposite the first end, the two openings being intended to receive the two conductive wires of the round cable the flat cable being connected to the connector once the connector has been inserted through the insertion slot.

### TECHNICAL FIELD

The present invention relates to an electrical extension system for a cable. The present invention also relates to an electrical extension kit for a cable and an assembly method.

### PRIOR ART

The traditional cables of today are thick and require a lot of work for the general public when they want to hide them, for example to install a television set or light fixture. A known technical solution to this problem is the use of cable troughs to conceal cables.

There are other options, but they involve costly work, the need for a professional, or an unsightly result.

What's more, existing connection systems generally comprise two round cables and connectors for connecting two round cables. On the one hand, however, round cable is difficult to carry in a narrow space and must be specially slotted for cabling. Round cable, on the other hand, is difficult to attach when wiring, and is difficult to cover with wallpaper or paint. As a result, the existing connection system is limited in practical applications. It is hard to adapt to a complicated wiring environment.

The aim of the present invention is to solve at least one of the above-mentioned shortcomings.

### DISCLOSURE OF THE INVENTION

This objective is achieved with an electrical extension system for a cable comprising at least one connection housing, said connection housing being formed by a lower portion coupled to an upper portion, the connection housing comprises a connector for electrically connecting a flat cable with a round cable, said round cable being composed of two conductive wires, each conductive wire being attached to the connector of said housing, the connection housing also comprising, at a first end, an insertion slot in its lower portion thereof for the passage of the flat cable and two openings at a second end, opposite the first end, the two openings being intended to receive the two conductive wires of the round cable, the flat cable being connected to the connector once it has been inserted through said insertion slot.

The flat cable in this system corresponds to a flat electrical cable that can be glued to any surface and concealed under paint, wallpaper, or tiles without the need for any renovations.

The flat cable has been tested in France, does not catch fire, and meets all safety standards. The flat cable allows the use of up to 16 amps and 3000 watts with approximately 1.5 mm2 of copper (cutting surface), at 230 volts.

A connector here is a domino-type element.

The extension system allows the flat cable to be positioned in areas where the user does not wish to have visible cables.

The flat cable can be cut to any length by the user, enabling the system to be adapted to any conditions of use, such as plugging in a light fixture or television set.

The system is therefore discreet and aesthetically pleasing to the eye, while keeping costs to a minimum for the user.

The connector can comprise two assembly portions and an extension portion connecting the two assembly portions, each of the conductive wires of the round cable being accommodated in one of the assembly portion, the second assembly portion being provided with an insertion groove for receiving said flat cable.

The connector accommodates both a flat cable and a round cable in a single element, and enables connection between said two cables.

The extension portion can comprise an opening configured to receive a closure element.

Each assembly portion can comprise at least one protruding element, each protruding element comprising an opening configured for attaching the cable accommodated in said assembly portion.

Each assembly portion can comprise at least one assembly element location configured to fixedly accommodate an assembly element in said assembly element location.

Each assembly element can comprise two accommodating portions, the first corresponding to a round cable accommodating portion, the second corresponding to a flat cable accommodating portion, the flat cable accommodating portion comprising an accommodating groove.

The system may also comprise at least one closing element. The closing element may be a screw, for example, or any other equivalent element. The closing element makes it possible to fasten the upper portion, the connector, and the lower portion of the housing together.

The connector may also comprise at least one fastening element. The fastening element of the connector is used to connect the flat cable to the round cable. When in use, the flat cable is inserted into the connector via the insertion slot, then the fastening element is tightened so that it pierces the copper of the cable. This is how the signal is transmitted through the connector to the round cable. The fastening element also enables said cables to be fastened inside the connector.

The element may be a screw, for example, or any other equivalent means.

The upper portion of the housing and the lower portion of the housing can comprise a means of closing said housing.

Means of closing refers, for example, to a protuberance for the lower portion and an opening for the upper portion. These means of closing allow a closing element such as a screw to pass through to close the entire system. The above-mentioned means of closing are non-limiting. Other equivalent means can also be used.

The housing can be made up of one and the same portion, the upper portion being connected to the lower portion by one of the sides of each portion. This makes it easier to close the housing, and potentially prevents the loss of components during the assembly thereof.

The flat cable can be 1.97 cm wide and 0.25 mm thick. This width allows easy insertion of the flat cable into the connector for the user, while ensuring a good connection between the flat cable and the round cable. In fact, with this width and thickness of flat cable, the fastening means cross the cable optimally, and at the right place to ensure the connection.

Said system can comprise at least one second connection housing, said second connection housing being formed by a lower portion coupled to an upper portion,

said second connection housing comprising a connector for electrically connecting a flat cable with a round cable, said round cable being composed of two conductive wires, each conductive wire being attached to the connector of said housing,
the second connection housing also comprises, at a first end, an insertion slot in its lower portion thereof for inserting the flat cable and two openings at a second end, opposite the first end, the two openings being intended to receive the two conductive wires of the round cable,
the flat cable being connected to the electrical connector once it has been inserted through said insertion slot,
each end of the flat cable being connected to a connection housing.

This objective is also achieved with a cable extension kit comprising the following elements:
a flat cable with a defined length,
a male adapter linked by a round cable and connected to a first system according to the invention,
a female adapter linked by a round cable and connected to a second system according to the invention,
a circular wire comprising two conductors stripped at each end,
at least one closing element for each housing of each system.

The kit can be adapted to suit any application. This is because the length of the flat cable can be adapted to suit the user's needs. The user cuts the flat cable to the desired length. The kit also provides a round cable comprising a male plug, a round cable comprising a female plug, and a round cable comprising conductive wires stripped at the ends.

The connectors are used to conduct current between the flat cable and round cable. The connectors are used in pairs: on one side is the traditional male plug for current collection, and on the other a female plug for connecting (electrical or electronic) products, or a stripped cable for direct connection to the light fixture.

The user can then build their system according to the desired connection. These different options enable the user to adapt the system according to their needs.

Said kit may further comprise the following elements:
at least one means of fastening said flat cable,
at least one means of fastening each housing of each system,
at least one accessory configured to secure at least one closure element of each housing.

Advantageously, the means of fastening said flat cable may correspond to strong glue or double-sided adhesive, for example. This means of fastening enables the flat cable to be positioned and fastened on the defined surface. Advantageously, the flat cable's double-sided adhesive has the same dimensions as said flat cable. The means of fastening each housing may be a double-sided adhesive patch. This means of fastening allows the user to fasten or unfasten the housings of the system to secure the system (no risk of dropping, for example). Advantageously, the adhesive patch has the same dimensions as the housings to be attached.

The kit may also comprise a strip of adhesive wallpaper designed to cover said flat cable once it has been positioned and fastened.

The kit also makes it possible to offer a low-cost extension cord, since all assembly is carried out by the user on their own, without the need for costly major renovations.

This objective is also achieved with a method for assembling an electrical extension kit for a cable according to the invention, the method comprising the following steps:
cutting the flat cable to a desired length,
connecting a first end of the flat cable with a first connector, the flat cable first being inserted into the insertion slot of the housing of said system,
closing the system via a closing element, connecting a second end of the flat cable with a second connector via a fastening element, the flat cable first being inserted into the insertion slot of the housing of said system, closing the system via a closing element.

It is simple and intuitive for the user to assemble the electrical extension kit. This allows anyone to change the cable to achieve a more aesthetically pleasing and much less costly result than the systems proposed by the prior art.

### DESCRIPTION OF THE FIGURES AND EMBODIMENTS

Other benefits and features of the invention shall become evident upon examining the detailed description of entirely non-limiting implementations and embodiments, and from the following enclosed drawings:

FIG. 1 shows a connection housing connected to a round cable according to the invention,

FIG. 2a shows the inner face of an upper portion of the housing according to the invention.

FIG. 2b shows the outer face of an upper portion of the housing according to the invention.

FIG. 2c shows a first profile view of the upper portion of the housing according to the invention.

FIG. 2d shows a second profile view of the upper portion of the housing according to the invention.

FIG. 2e shows a third profile view of the upper portion of the housing according to the invention.

FIG. 3a shows the inner face of a lower portion of the housing according to the invention.

FIG. 3b shows the outer face of a lower portion of the housing according to the invention.

FIG. 3c shows a first profile view of the lower portion of the housing according to the invention.

FIG. 3d shows a second profile view of the lower portion of the housing according to the invention.

FIG. 3e shows a third profile view of the lower portion of the housing according to the invention.

FIG. 3f shows the inner face of a lower portion of the housing comprising an electrical connector of the housing according to the invention.

FIG. 4a shows a top view of an electrical connector according to the invention.

FIG. 4b shows a bottom view of an electrical connector according to the invention.

FIG. 4c shows a first profile view of an electrical connector according to the invention.

FIG. 4d shows a second profile view of an electrical connector according to the invention.

FIG. 4e shows a third profile view of an electrical connector according to the invention.

FIG. 4f shows a fourth profile view of an electrical connector according to the invention.

FIG. 5a shows a top view of an assembly element according to the invention.

FIG. 5b shows a profile view of an assembly element according to the invention.

FIG. 5c shows a first front view of an assembly element according to the invention.

FIG. 5d shows a second front view of an assembly element according to the invention.

FIG. 6 describes a flat cable.

These embodiments are in no way limiting, and, in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior art. This selection comprises at least one preferably functional feature which lacks structural details, and/or only has a portion of the structural details if that portion alone is sufficient to confer a technical benefit or to differentiate the invention with respect to the prior art.

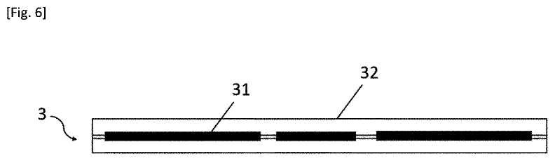

The electrical extension system for a cable of the present invention comprises a flat cable 3, a round cable 2, and a connector 4 for electrically connecting the flat cable 3 and the round cable 2. The round cable 2 is a general round cable from the prior art and will not be described. The flat cable 3 is described in FIG. 6 and comprises two wires 31 and one sheath 32. The wire 31 is flat and is used to conduct signals. The outer sheath 32 is made of an insulating material that covers the two wires 31 and insulates them from each other. The outer sheath 32 also flattens the flat cable 3 as a whole. Preferentially, the flat cable 3 uses copper and Polyethylene Terephthalate (PET) with the precise dimensions of 1.97 cm width and 0.25 mm thickness. Other dimensions may be used in other embodiments.

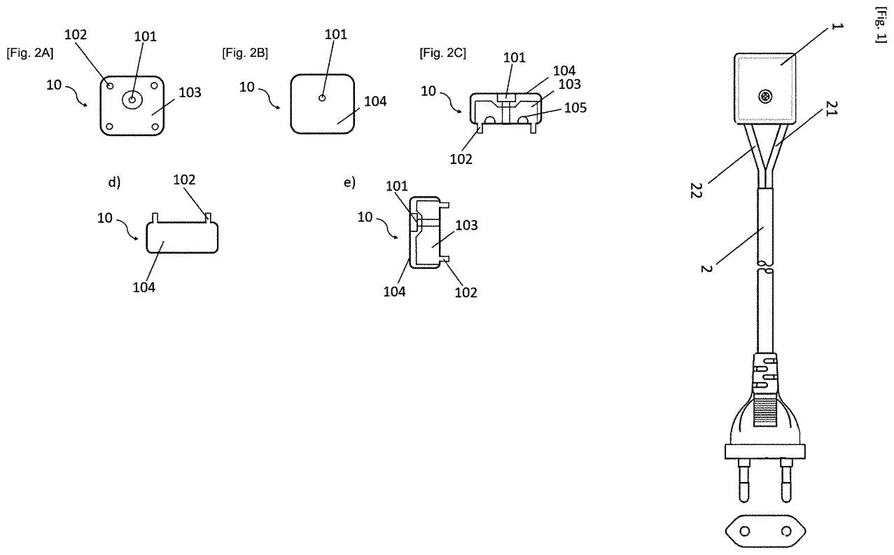

FIG. 1 depicts a round cable 2 connected at one end to a wall outlet, called a male plug. At its second end, the round cable 2 is divided into two wires 21 and 22, which are connected to the connection housing 1. In other embodiments, the first end of the round cable can be connected to a female socket. This first end can also correspond to the two bare cables 21 and 22. The connection housing 1 is square in shape. In other embodiments, the housing 1 may have a circular, rectangular, or other shape. The housing 1 consists of an upper portion 10 and a lower portion 11 configured to be coupled. A connector 4 is placed inside the housing 1 when the two parts 10, 11 of the housing 1 are assembled.

Referring to FIG. 2a) to e), the upper portion 10 comprises an opening 101 which corresponds to a circular opening, an inner face 103, an outer face 104 and four sides projecting from the inner face 103. The opening 101 comprises two portions, a first portion wider than the second allowing a closing element, such as a screw for example, to come to bear and a second, long portion allowing the closing element to pass through to close the housing. On its inner face 103, the upper portion 10 comprises four engagement elements such as studs 102 projecting from the four corners of the square shape of said upper portion 10. The four engagement elements 102 ensure that the upper portion of the housing 10 is correctly positioned on the lower portion 11. The opening 101 is off-center. FIG. 2c) shows a profile section of the upper portion 10. The upper portion 10 further comprises two semi-circular through-notches 105 on one of its sides, designed to accommodate the conductive wires 21 and 22 of the round cable. The other three sides of the upper section 10, as shown for example in FIG. 2d), are solid.

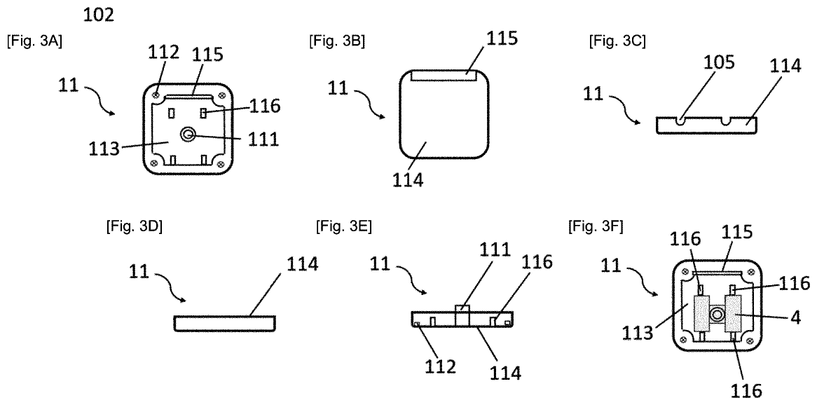

Referring to FIG. 3a) to f), the connection housing 1 comprises a lower portion 11. The lower portion 11 is square, like the upper portion 10. The upper portion 10 and lower portion 11 have the same shape whatever the embodiment. The lower portion 11 comprises an inner face 113, an outer face 114 and four sides projecting from the inner face 113. The height of the sides of the lower portion 11 is less than the height of the sides of the upper portion 10. On its inner face 113, it comprises four engagement elements 112 positioned at the four corners, four positioning elements 116 and a protuberance 111 for closing the housing 1. The engagement elements 112 are configured to mate with the engagement elements 102. In the embodiment shown, the engagement elements 112 correspond to engagement holes. Each engagement hole 112 cooperates with each projecting stud 102 to engage the upper portion 10 with the lower portion 11 to form a closed reception space receiving the connector 4. The protuberance 111 is hollow and positioned so as to face the opening 101 of the upper portion 10. The lower portion 11 further comprises an insertion slot 115 positioned on the inner face 113 along one of the sides of the lower portion 10. The lower portion 11 comprises two semi-circular through-notches 105 on the side opposite the position of the insertion slot 115 (see FIG. 3c), the two remaining sides being solid (see FIG. 3d). The positioning elements 116 enable the connector 4 to be correctly positioned within the housing 1, as shown in FIG. 3f), and to be held in position. The connector 4 is then held in place by said four positioning elements 116.

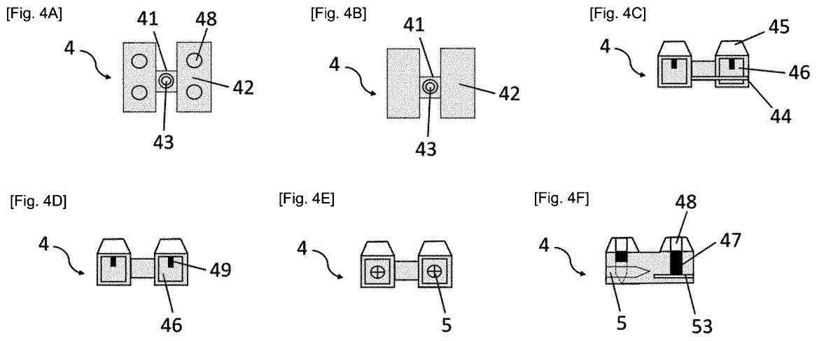

Referring to FIG. 4a) to 4f), the connector 4 comprises an extension portion 41 and two assembly portions 42 on either side of the extension 41. The extension portion 41 is formed on a side surface of one assembly portion 42, and extends to another assembly portion 42, thus connecting the two assembly portions 42 in such a way that the two assembly portions 42 are arranged symmetrically on either side thereof. The extension 41 comprises an opening 43 designed to accommodate a closing element. This opening 43 rests on the protrusion 111 of the lower portion 11 and accommodates the opening 101 above it when the two housing parts are assembled. Each assembly portion 42 comprises two protruding elements 45 on its upper surface, each protruding element 45 comprising an opening configured to accommodate a fastening element. Each opening 43 goes all the way through. Each assembly portion 42 is hollow, this hollow corresponding to an assembly element location 46. The assembly element location 46 comprises a locking element 49 designed to lock the assembly element 5 when positioned in the location 46. The locking element 49 corresponds to a downwardly protruding element. Each assembly portion 42 further comprises an insertion groove 44 at one end, designed to accommodate one end of the flat cable (see FIG. 4c). The connector 4 further comprises an assembly element 5 (see FIG. 4e) fixedly accommodated in an assembly element location 46 of the electrical connector 4.

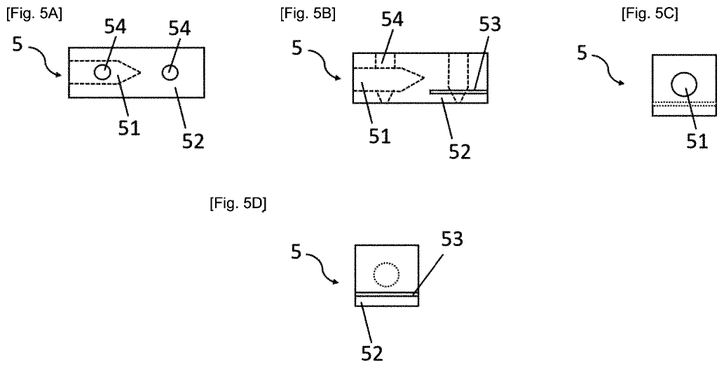

According to FIGS. 4f) and 5a) to d), the assembly element 5 is made of insulating material and has two accommodating portions at each end, the first one corresponding to a round cable accommodating portion 51, the second one corresponding to a flat cable accommodating portion 52. The round cable accommodating portion 51 comprises a substantially cylindrically-shaped recess configured to accommodate a conductive wire 21 or 22 of the round cable. The flat cable accommodating portion 52 comprises an accommodating groove 53. The accommodating groove 53 is arranged in the lower portion of the assembly element 5. The accommodating groove 53 communicates with the insertion groove 44 of the connector 4.

FIG. 4f) shows the assembly element 5 positioned in the connector 4 with two fastening elements. The fastening element is used to connect the flat cable 3 or round cable 2 with the connector 4.

The connector 5 is placed in the receiving space formed by the upper portion 10 and the lower portion 11 of the housing 1. The fastening element passes sequentially through the fastening opening 101 of the upper portion 10, the opening 43 of the connector 4, and is secured in the protuberance 111 of the lower portion 11. The opening 43 fastens the connector in the lodging space.

An assembly element 5 is fastened in each assembly element slot 46. In the embodiment shown, two assembly elements 5 are fastened in the connector 4. The assembly elements 5 abut against each locking element 49. The two wires 21 and 22 of the round cable are respectively inserted into the receiving holes 51 of the two assembly elements 5. The two conductive wires 21 and 22 are fastened by a fastening element. The fastening element is inserted into each opening 48 and tightened. The fastening element is, for example, a screw. Once positioned, the user screws it into the connector 4.

The flat cable 3 is then inserted first into the insertion slot 115 and then into the accommodating groove 44 of the two assembly elements 5. The fastening element is passed through each remaining opening 48 to fasten the flat cable 3.

The connector 4 is then installed on the inner face 113 of the lower portion 11 of the housing via the positioning elements 116 and the opening 43 of the connector 4 is positioned on the protuberance 111 of the lower portion 11 of the housing 1.

The notches 105 in the upper portion 10 and lower portion 11 correspond to each other, so that they form circular openings when the two parts of the housing are joined. The two conductive wires 20 and 21 pass through said openings.

In a second embodiment, said system further comprises a second housing as described above. It is fastened to the second end of the flat cable 3 in the same way as described above. The flat cable 3 is then connected at one end to a male plug and at a second end to a female plug, forming an extension.

In yet another embodiment, the housing 1 comprises a connector 4 for connecting two flat cables together. In this embodiment, the connector comprises two assembly elements, each assembly element comprising two flat cable receiving portions. Each portion of each assembly element then comprises an accommodating groove.

Also described is an electrical cable extension kit comprising the following elements:
a flat cable 3 with a defined length,
a male adapter linked by a round cable 2 and connected to a first system as previously described,
a female adapter linked by a round cable 2 and connected to a second system as previously described,
a circular wire comprising two conductors stripped at each end,
at least one closing element for each housing of each system.

The kit may further comprise the following elements:
at least one means of fastening said flat cable,
at least one means of fastening each housing of each system,
at least one accessory configured to secure at least one closure element of each housing.

A method for assembling a cable extension system in a kit according to any one of claims 13 to 14 is also described, the method comprising the following steps:
cutting the flat cable to a desired length,
connecting a first end of the flat cable with a first connector, the flat cable first being inserted into the insertion slot of the housing of said system,
closing the system via a closing element,
connecting a second end of the flat cable with a second connector via a fastening element, the flat cable first being inserted into the insertion slot of the housing of said system,
closing the system via a closing element.

First, the user takes possession of the electric cable extension kit. The user measures the cable length required for their application. For example, to connect a wall-mounted television set, the user may need a two-meter-long flat cable. The user cuts the flat cable 3 to the desired length.

The kit comprises two systems, each with a connector 4 already connected to a round cable 2. One system comprises a male plug, the other a female plug at the end of said round cable. In other embodiments, the round cable 2 of the system may not already be connected to the connector 4. In this specific case, the user must also connect the round cable 2 in the same way as the flat cable 3.

Generally speaking, the connector comprises four fastening elements already positioned in the projecting elements 45 via the fastening holes 48. In this case, the fastening elements are screws.

As previously described, the housing comprises an upper portion 10 and a lower portion 11. The user separates the two parts if they are already pre-assembled and accesses the connector 4. The user takes the lower portion 11, one end of the flat cable, and passes it through the insertion slot 115 of said lower portion 11. The user then unscrews the two fastening elements positioned on the portion comprising the accommodating groove 44. The user slides the end of the flat cable into this accommodating groove, then fastens it with said fastening elements. The fastening elements are then tightened using an accessory such as a screwdriver. The user then positions the connector on the lower portion 11 of the housing 1 via the positioning elements 116 and closes the housing again by positioning the upper portion 10 on the lower portion 11. The user completes the assembly of the first system by fastening the housing assembly 1 with a closing element. The closing element can be fastened with the same accessory supplied in the kit.

Once the first system has been installed at the first end of the flat cable 3, the user does the same with the second system provided at the second end of the flat cable. The electrical extension device is then assembled.

As needed, the user may also exchange a round cable 2 connected to a male or female plug for a round cable 2 comprising conductive wires stripped at each end. On the same principle as installing the flat cable 3 in the connector 4, the user loosens the fastening means on the side of the round cable 2. The user removes the conductive wires from the connector 4, and positions the new ones in their place. The user can then re-attach the new wires using the fastening elements.

Of course, the invention is not limited to the examples just described, and many adjustments can be made to these examples without going beyond the scope of the invention.

Of course, the various features, forms, variants and embodiments of the invention may be combined with each other in various combinations as long as they are not incompatible or exclusive of each other. In particular, all the variants and embodiments described above can be combined with each other.

1. An electrical extension system for a cable, comprising: at least one connection housing and at least one flat cable; said connection housing being formed by a lower portion coupled to an upper portion;
the connection housing comprising a connector that allows a flat cable to be electrically connected to a round cable; said round cable being composed of two conductive wires, each conductive wire being attached to the connector of said housing;
the connection housing also comprising, at a first end, an insertion slot in the lower portion thereof for the passage of the flat cable and two openings at a second end, opposite the first end, the two openings being intended to receive the two conductive wires of the round cable;
the flat cable being connected to the connector once said connector has been inserted through said insertion slot; and
wherein the flat cable is 1.97 cm wide and 0.25 mm thick.

2. The system according to claim 1, wherein the connector comprises two assembly portions and an extension portion connecting the two assembly portions, each of the conductive wires of the round cable being received in one of the assembly portions, the second assembly portion being provided with an insertion groove for receiving said flat cable.

3. The system according to claim 2, wherein the extension portion comprises an opening configured to receive a closure element.

4. The system according to claim 2, wherein each assembly portion comprises at least one protruding element, each protruding element comprising an opening configured for fastening the cable accommodated in said assembly portion.

5. The system according to claim 2, wherein each assembly portion comprises at least one assembly element location configured to fixedly accommodate an assembly element in said assembly element location.

6. The system according to claim 5, wherein each assembly element comprises two accommodating portions, the first corresponding to a round cable accommodating portion, the second corresponding to a flat cable accommodating portion, the flat cable accommodating portion comprising an accommodating groove.

7. The system according to claim 1, wherein the system further comprises at least one closure means.

8. The system according to claim 1, wherein the connector further comprises at least one fastening element.

9. The system according claim 1, wherein the upper portion of the housing and the lower portion of the housing comprise an element for closing said housing.

10. The system according to claim 1, wherein the housing is composed of one and the same portion, the upper portion being connected to the lower portion by one of the sides of each portion.

11. The system according to claim 1, wherein said system comprises at least one second connection housing, said second connection housing being formed by a lower portion coupled to an upper portion;
said second connection housing comprising a connector for electrically connecting a flat cable with a round cable, said round cable being composed of two conductive wires, each conductive wire being attached to the connector of said housing;
the second connection housing also comprising, at a first end, an insertion slot in its lower portion thereof for inserting the flat cable and two openings at a second end, opposite the first end, the two openings being intended to receive the two conductive wires of the round cable;
the flat cable being connected to the electrical connector once it has been inserted through said insertion slot; and
each end of the flat cable being connected to a connection housing.

12. An electrical extension kit for a cable comprising the following elements:
a flat cable with a defined length;
a male adapter linked by a round cable and connected to a first system according to claim 1;
a female adapter linked by a round cable and connected to a second system according to claim 1;
a circular wire comprising two conductors stripped at each end; and
at least one closing element for each housing of each system.

13. The kit according to claim 12, said kit also comprising the following elements:
at least one means of fastening said flat cable;
at least one means of fastening each housing of each system; and
at least one accessory configured to secure at least one closure element of each housing.

14. A method for assembling a cable extension kit according to claim 12, the method comprising the following steps:
cutting the flat cable to a desired length;
connecting a first end of the flat cable with a first connector, the flat cable first being inserted into the insertion slot of the housing of said system;
closing the system via a closing element;
connecting a second end of the flat cable with a second connector via a fastening element, the flat cable first being inserted into the insertion slot of the housing of said system; and
closing the system via a closing element.
